(19) United States
(12) Patent Application Publication
(10) Pub. No.: US 2017/0275458 A1
(43) Pub. Date: Sep. 28, 2017

(54) POLYAMIDE RESIN COMPOSITION COMPRISING FIBER REINFORCED POLYAMIDE PELLET AND MOLDED ARTICLE THEREOF

(71) Applicants: Hyundai Motor Company, Seoul (KR); Samyang Corporation, Seoul (KR)

(72) Inventors: Dong Jun Lee, Suwon (KR); Do Young Bae, Daejoen (KR); Woo Ju Lee, Seoul (KR); Seung Chan Ryu, Daejeon (KR); Hyung Jin Roh, Daejeon (KR)

(21) Appl. No.: 15/379,825

(22) Filed: Dec. 15, 2016

(30) Foreign Application Priority Data
Mar. 24, 2016 (KR) 10-2016-0035325

(51) Int. Cl. C08L 77/06; F01P 11/10; B29C 45/00

(52) U.S. Cl. CPC C08L 77/06; B29C 45/0005; B29C 45/0001; F01P 11/10; C08L 2205/025; C08L 2205/03; C08L 2207/20; B29K 2077/00

(57) ABSTRACT

Disclosed are a polyamide resin composition comprising a fiber reinforced polyamide pellet, a molded article comprising the polyamide resin composition and a method of manufacturing the molded article. The polyamide resin composition includes the fiber reinforced polyamide pellet, which can be produced by pultrusion, such that moldability and mechanical properties of molded articles may be sufficient using the recycled polyamide 66 resin. In addition, although the polyamide resin composition contains a less amount of inorganic substance, mechanical properties of the molded article are sufficient, weight of molded articles can be reduced and production costs can be reduced.

### CROSS-REFERENCE TO RELATED APPLICATION

This application claims under 35 U.S.C. §119(a) the benefit of priority to Korean Patent Application No. 10-2016-0035325 filed on Mar. 24, 2016, the entire contents of which are incorporated herein by reference.

### TECHNICAL FIELD

The present invention relates to a polyamide resin composition suitable for production of radiator shrouds, and a molded article thereof. In particular, the polyamide resin composition may include a fiber reinforced polyamide pellet produced by pultrusion such that the fiber reinforced polyamide pellet can overcome limitations on moldability and mechanical properties of molded articles produced using a polyamide resin composition containing a recycled polyamide 66 resin.

### BACKGROUND

In accordance with the Europe Union (EU)'s End-of-Life Vehicle Directive (2000/53/EC) and laws on the resource circulation of electrical and electronic equipment and vehicles, new vehicles launched from 2015 should meet reuse/recovery rates of 95% and waste vehicles should meet reuse/recovery rates of 95%. When the reuse/recovery rate is less than 95%, sales of new vehicles are restricted and manufacturers of finished vehicles not meeting waste vehicle reuse/recovery rates of 95% should pay an annual waste charge.

Accordingly, vehicle manufacturers inevitably have been interested in recovering waste vehicles and thus have paid more attention to research on recycling of waste vehicles.

Meanwhile, one vehicle includes about 250 kg of a plastic (based on medium vehicles) which includes about 40% of polypropylene (PP), about 10% of polyamide (PA), about 9% of polyurethane (PUR), about 7% of polyethylene (PE), about 5% of ABS and about 29% of other plastic.

Among these, polypropylene, polyamide and polyurethane, which are present in high proportions, may be reused with various technical developments.

In particular, recycling technologies of polypropylene and polyurethane produced from waste vehicles have been developed and utilized in a variety of vehicle components, but technical development on recycling of polyamide as an engineering plastic has not been sufficient. For example, polyamide has been generally used for vehicle functional components, however, it may be difficult for it to satisfy required physical properties of recycled materials.

Accordingly, there is a need for a polyamide resin composition, which can provide both mechanical properties and low weight of molded articles and particularly includes a recycled polyamide 66 resin.

### SUMMARY OF THE INVENTION

In preferred aspects, the present invention may provide a polyamide resin composition including a recycled polyamide 66 resin, a fiber reinforced polyamide, and a non-recycled polyamide 66 resin. In particular, the fiber reinforced polyamide may be formed in a pellet which may be obtained by impregnating a reinforcing fiber with a polyamide 66 resin through pultrusion. Accordingly, when a molded article is made of the polyamide resin composition, weights of components may be reduced and mechanical properties may be satisfied as well as moldability.

In one aspect of the present invention, provided is a polyamide resin composition comprising a recycled polyamide 66 resin, a fiber reinforced polyamide, and a non-recycled polyamide 66 resin. In particular, the fiber reinforced polyamide may be formed in a pellet.

As referred to herein, a “recycled polyamide 66 resin” indicates to a polyamide 66 resin recovered or recycled from a wasted substance that may contain substantial amount of polyamide 66 resin, for example, greater than about 5 wt %, greater than about 10 wt %, greater than about 20 wt %, greater than about 30 wt %, greater than about 40 wt %, greater than about 50 wt %, greater than about 60 wt %, greater than about 70 wt %, greater than about 80 wt %, or greater than about 90 wt %, based on the total weight of the wasted substance. Accordingly, recycled polyamide 66 resin as used herein may comprise polyamide 66 as a major component, which suitably may constitute, for example, greater than about 50 wt %, greater than about 60 wt %, greater than about 70 wt %, greater than about 80 wt %, or greater than about 90 wt %, or preferably, from about 60-80 wt % of the total weight of the recycled polyamide 66 resin. Preferred source and/or method of preparing the recycled polyamide 66 resin includes crushing, cleaning, blending and chain-elongation of radiator shrouds, radiator fans, radiator end tanks and engine covers derived from waste vehicles.

As referred to herein, a “non-recycled polyamide 66 resin” indicates to a polyamide 66 resin manufactured, synthesized, or polymerized from raw materials such as hexamethylenediamine and adipic acid. Preferred source and/or method of preparing the non-recycled polyamide 66 resin includes synthesizing, by polycondensation, of hexamethylenediamine and adipic acid with water in a reactor.

As referred to herein, a “reinforced” indicates to being improved in physical or mechanical properties such as strength, durability or the like, by additional component, such as fiber, or treatment in a material or composition.

As referred to herein, a “pellet” indicates to a material or substance in a particular form, for example, rounded, oval, square, rectangular, octagonal, polygonal, spherical, or cylindrical body, and the like, or general shapes without particularly limitation to a size or dimension. The pellet as used herein suitably may have an oval or cylindrical three-dimensional shape, such as having an average length greater than an average diameter thereof, for example, by about 250 times, by about 500 times, by about 750 times, by about 1000 times, by about 1500 times, by about 2000 times, or greater. Preferred source and/or method of preparing the pellet comprising the polyamide resin and reinforcement components may include impregnating, by pultrusion, reinforcement fiber with polyamide resin.

In one preferred aspect, the polyamide resin composition may comprise: an amount of about 30 to 60% by weight of a recycled polyamide 66 resin; an amount of about 10 to 50% by weight of a fiber reinforced polyamide; and an amount of about 5 to 60% by weight of a non-recycled polyamide 66 resin. All the % by weights are based on the total weight of the polyamide resin composition.

Preferably, the recycled polyamide 66 resin may be obtained from radiator shrouds, radiator fans, radiator end tanks and engine covers derived from waste vehicles. The recycled polyamide 66 resin suitably may comprise amount of about 20 to 40% by weight of an inorganic substance based on the total weight of the recycled polyamide 66 resin. The inorganic substance may include a glass fiber, a mineral powder or the like. In particular, the mineral powder may comprise kaolin, wollastonite, or a mixture thereof.

Preferably, the fiber reinforced polyamide may be formed in a pellet. The fiber reinforced polyamide pellet suitably may have an average length of about 5 to 30 mm and an average diameter of about 15 to 20 on.

Preferably, the fiber reinforced polyamide may be obtained by impregnating a reinforcing fiber with a polyamide 66 resin having a relative viscosity of about 2 to 3, based on a value measured using a solution of 1 g of a polyamide 66 resin in 100 ml of 96% sulfuric acid at a temperature of 20° C.

In one aspect, the present invention may provide a method of manufacturing a molded article, and the method may comprise: obtaining a recycled polyamide 66 resin from radiator shrouds, radiator fans, radiator end tanks and engine covers derived from waste vehicles; preparing a fiber reinforced polyamide by impregnating a reinforcing fiber with a polyamide 66 resin having a relative viscosity of about 2 to 3, based on a value measured using a solution of 1 g of a polyamide 66 resin in 100 ml of 96% sulfuric acid at a temperature of 20° C.; preparing a resin composition by mixing the recycled polyamide 66 resin, the fiber reinforced polyamide and a non-recycled polyamide 66 resin; and forming a molded article by dry-blending and injection molding the resin composition.

The recycled polyamide 66 resin suitably may comprise an amount of about 20 to 40% by weight of a glass fiber and a mineral powder based on the total weight of the recycled polyamide 66 resin. For instance, the mineral powder may comprise kaolin, wollastonite, or a mixture thereof.

Preferably, the fiber reinforced polyamide may be formed in a pellet and impregnated by pultrusion into the pellet. The fiber reinforced polyamide formed in the pellet suitably may have an average length of about 5 to 30 mm and an average diameter of about 15 to 20 μm.

The recycled polyamide 66 resin and the fiber reinforced polyamide may be air-dried at a temperature of about 110 to 120° C., and the non-recycled polyamide 66 resin may be air-dried at a temperature of about 70 to 80° C.

In another aspect of the present invention, provided is a molded article comprising the polyamide resin composition as described herein. The molded article may include a radiator shroud, for example, for a vehicle.

Further provided in the present invention is a vehicle that may comprise the resin composition or the molded article comprising the resin composition as described herein.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 illustrates an exemplary process using an exemplary pultrusion device;

FIG. 2 illustrates an exemplary fiber reinforced polyamide pellet according to an exemplary embodiment of the present invention;

FIG. 3 illustrates components of an exemplary polyamide resin composition and a dry blend thereof according to an exemplary embodiment of the present invention; and

FIG. 4 illustrates an exemplary radiator shroud as a molded article according to an exemplary embodiment of the present invention.

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, an embodiment of the present invention will be described in more detail.

The present invention provides a fiber reinforced polyamide pellet which may include a recycled resin from waste vehicles and may reduce or overcome limitations on moldability and mechanical properties.

The fiber reinforced polyamide pellet according to the present invention may have an average length of about 5 to 30 mm and an average diameter of about 15 to 20 on. Preferably, the fiber reinforced polyamide pellet may be obtained by impregnating a reinforcing fiber with a polyamide 66 resin, for example, by pultrusion. The polyamide 66 resin may have a relative viscosity of about 2 to 3 based on a value measured using a solution of 1 g of a polyamide 66 resin in 100 ml of 96% sulfuric acid at a temperature of about 20° C.

Preferably, the fiber reinforced polyamide pellet according to an exemplary embodiment of the present invention may be produced using a pultrusion device shown in FIG. 1 and may be obtained by injecting a polyamide 66 resin into a resin injection part of the pultrusion device, impregnating a reinforcing fiber having a robe-type with a polyamide 66 resin by pulling and squeezing while passing through the pultrusion device, and pultruding the impregnated reinforcing fiber into continuous-phase strands, followed by cooling and cutting into a pellet.

The fiber reinforced polyamide pellet thus obtained preferably may have an average length of about 5 to 30 mm and an average diameter of about 15 to 20 on. When the average length of the pellet is less than about 5 mm, improvement in mechanical properties of the polyamide resin composition may not be sufficient and when the average length of the pellet is greater than about 30 mm, molding processes may not be easy and qualities of products may thus deteriorate due to the reduced flowability of the polyamide resin composition. When the average diameter of the pellet is less than about 15 μm, the diameter of the pellet may be similar to that of the fiber strands and processability may be degraded, and when the average diameter of the pellet is greater than about 20 μm, controlling the content of fibers in pellet may not be controlled properly. Thus, the length and diameter of the fiber reinforced polyamide pellet may be preferably within the range defined above.

In addition, the polyamide 66 resin suitably may have a relative viscosity of about 2 to 3, or particularly of about 2.3 to 2.7. The “relative viscosity” may be obtained from a value measured using a solution of 1 g of a polyamide 66 resin in 100 ml of 96% sulfuric acid at a temperate of 20° C. When the relative viscosity of the polyamide 66 resin is less than about 2, mechanical properties may not be obtained sufficiently, and when the relative viscosity of the polyamide 66 resin is greater than about 3, flowability may deteriorate significantly and processing and production may be limited. Thus, use of a polyamide 66 resin having a viscosity satisfying the range defined above is preferred.

The reinforcing fiber may include one or more selected from the group consisting of glass fibers, carbon fibers, metal fibers, aramid fibers, polyethylene terephthalate (PET) fibers, polyetheretherketone (PEEK) fibers, ultrahigh molecular weight polyethylene fibers, liquid crystal polymer (LCP) fibers, polyacrylonitrile (PAN) fibers, arylate fibers, rayon fibers, polyamide fibers and natural fibers. In consideration of environmental friendliness, natural fibers may be preferably used. These have respectively advantages and functions, and are thus selected and combined according to properties required for molded articles.

Furthermore, in order to improve miscibility with the polyamide 66 resin, the fiber reinforced polyamide pellet may be preferably surface-treated with one or more coupling agents selected from the group consisting of silane, titanate, chromium, zirconium, borane and aluminum, or with an acid.

Further, the present invention may provide a polyamide resin composition comprising the fiber reinforced polyamide pellet as described herein.

In an exemplary embodiment, the polyamide resin composition may comprise (a) an amount of about 30 to 60% by weight of a recycled polyamide 66 resin; (b) an amount of about 10 to 50% by weight of a fiber reinforced polyamide pellet; and (c) an amount of about 5 to 60% by weight of a non-recycled polyamide 66 resin, all the % by weight based on the total weight of the polyamide resin composition.

Preferably, the recycled polyamide 66 resin may be a pelleted recycled polyamide 66 resin obtained by crushing, cleaning, blending and chain-elongation of radiator shrouds, radiator fans, radiator end tanks and engine covers from waste vehicles. Exemplary method may be indicated in Korean Patent No. 10-1575372, entire contents thereof are incorporated by reference.

The recycled polyamide 66 resin may include an amount of about 20 to 40% by weight, or particularly an amount of about 26 to 30% by weight of an inorganic substance, with respect to the total 100% by weight of the recycled polyamide 66 resin. The content of the inorganic substance may be measured from the residue left behind after combusting the recycled polyamide 66 resin. The inorganic substance may include a glass fiber, a mineral powder or the like. However, it may be difficult to satisfy mechanical properties of the molded articles with the content of the glass fiber and the mineral powder present in the recycled polyamide 66 resin. Accordingly, in one preferred aspect of the present invention, a predetermined amount of the fiber reinforced polyamide pellet may be incorporated into the polyamide resin composition. In this case, the glass fiber and the mineral powder contained as the inorganic substance in the recycled polyamide 66 resin may be present in a mix ratio of about 40-45:55-60. Here, the mineral powder may include kaolin, wollastonite or a mixture thereof.

Furthermore, in the polyamide resin composition according to the present invention, the recycled polyamide 66 (a) resin may be included in an amount of 30 to 60% by weight, or particularly of about 40 to 50% by weight, based on the total weight of the polyamide resin composition. When the content of the recycled polyamide 66 resin is less than about 30% by weight, the resin composition may not be an environmentally friendly material due to low content of the recycled resin in the resin composition, and when the content of the recycled polyamide 66 resin is greater than about 60% by weight, desired mechanical properties and other weatherability may not be sufficiently obtained. The recycled polyamide 66 resin may be preferably used within the content range defined above.

Then, the fiber reinforced polyamide pellet (b) may be included in an amount of about 10 to 50% by weight, or particularly of about 15 to 25% by weight, based on the total weight of the polyamide resin composition. When the fiber reinforced polyamide pellet is less than about 10% by weight, the specific gravity of molded articles may decrease, but strain may increase substantially and reinforcement of mechanical properties such as strength or durability may decrease. When the amount of the fiber reinforced polyamide pellet is greater than about 50% by weight, superior mechanical properties may be realized, but specific gravity of molded articles may increase, molding processability may deteriorate because the reinforcing fiber may be cut during processing, and uniformity of resin surfaces and dispersibility of glass fibers deteriorate. Thus, the fiber reinforced polyamide pellet may be preferably included within the range defined above.

The non-recycled (new) polyamide 66 resin (c) used in the polyamide resin composition according to the present invention suitably may have a relative viscosity of 2 to 3, or particularly of about 2.3 to 2.7. When the relative viscosity of the non-recycled polyamide 66 resin is less than about 2, mechanical properties may deteriorate, and when the relative viscosity of the non-recycled polyamide 66 resin is greater than about 3, processability may deteriorate, and impregnation properties of the reinforcing fiber and other additives may be thus degraded. Thus, the non-recycled polyamide 66 resin (c) may have a relative viscosity in the range defined above.

In addition, the non-recycled polyamide 66 resin (c) suitably may be included in an amount of about 5 to 60% by weight, or particularly of about 20 to 40% by weight, with respect to the total 100% by weight of the polyamide resin composition.

Meanwhile, the recycled polyamide 66 resin and the fiber reinforced polyamide pellet may be air-dried at a temperature of about 110 to 120° C., and the non-recycled polyamide 66 resin may be air-dried at a temperature of about 70 to 80° C. Accordingly, molded articles may be prepared as dry blending and injection-molding these components. When molded articles are may be produced without sufficient removal of moisture, mechanical properties and reliability of the molded articles will deteriorate since amide groups in the polyamide may be hydrolyzed upon exposure to moisture.

In addition, the polyamide resin composition may further include any additive for improvement of heat resistance, dimensional stability, dispersibility of the reinforcing fiber, or processability during molding.

In one exemplary embodiment, the polyamide resin composition may include one or more additive(s) selected from the group consisting of a neutralizing agent, an inorganic filler, a lubricant, an antioxidant, a nucleating agent, a light stabilizer, a hydrolytic stabilizer, a releasing agent, a flame retardant, an antistatic agent, a UV stabilizer, a brightener, a conductive agent, a magnetic imparting agent, a crosslinking agent, an antimicrobial agent, a processing aid, an anti-friction agent, an anti-abrasive agent, a coloring agent, a coupling agent, and a mixture thereof.

These additives may be included in an amount of about 0.1 to 5 parts by weight with respect to 100 parts by weight of the polyamide resin composition, without limitation thereto.

The polyamide resin composition according to the present invention may be produced into vehicle molded articles and may be useful as a resin suitable for production of, in particular, radiator shroud molded articles. In addition, the polyamide resin composition may have sufficient tensile strength, flexural strength, flexural modulus, impact strength and heat deflection temperature (HDT) as mechanical properties required for radiator shrouds, and furthermore, may be effective in reducing specific gravity and production costs.

### Example

Hereinafter, the present invention will be described with reference to examples in more detail. However, these examples are provided for illustration of the present invention and should not be construed as limiting the scope of the present invention.

### Preparation Example 1: Recycled Polyamide 66 Resin

A recycled polyamide 66 resin having 28% by weight of the total content of inorganic substances including the glass fiber and mineral powder (for example, a weight ratio of glass fiber to mineral powder=45:55), which was a recycled polyamide 66 resin produced according to Korean Patent No. 1,575,372, was purchased from TPECO. At this time, the mineral powder included kaolin and wollastonite.

### Preparation Example 2: Fiber Reinforced Polyamide Pellet

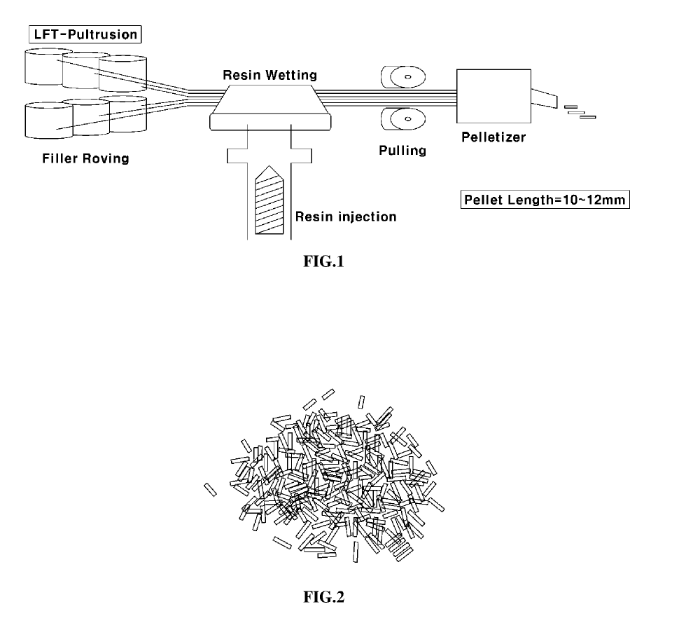

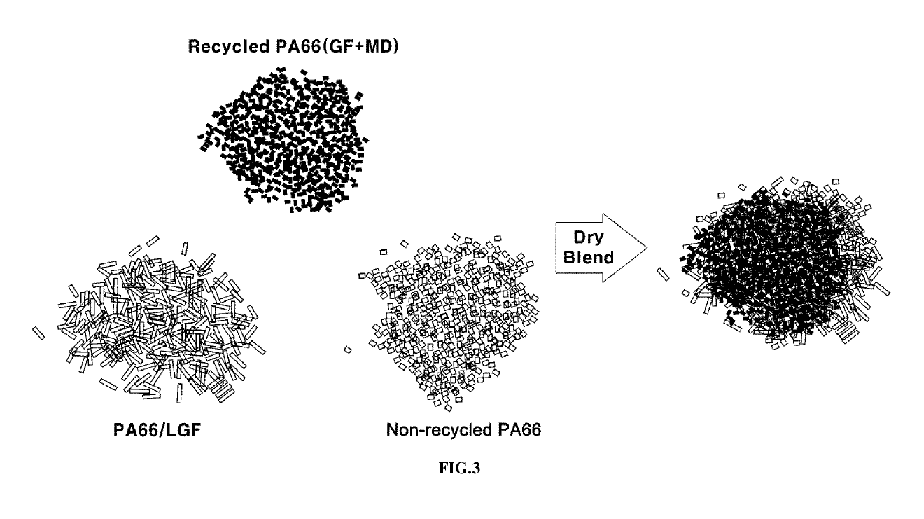

An amount of 65% by weight of a polyamide 66 resin having a relative viscosity to a sulfuric acid solvent of 2.3 was impregnated into 35% by weight of an E-glass-based glass fiber using a pultrusion device of FIG. 1. Thus prepared pellet had a length of 15 mm and a diameter of 17 on. More specifically, the polyamide 66 resin was injected into a resin injection part of the pultrusion device and a reinforcing fiber was impregnated with the polyamide 66 resin by pulling and squeezing while passing through a die to obtain a pellet. At this time, the pellet was surface-treated with a silane coupling agent and the pellet thus obtained can be seen from FIG. 2.

### Preparation Example 3: Non-Recycled Polyamide 66 Resin

A polyamide 66 resin which has a relative viscosity to a sulfuric acid solvent (based on a value measured using a solution of 1 g of a polyamide 66 resin in 100 ml of 96% sulfuric acid at a temperature of 20° C.) of 2.3 was prepared.

### Examples 1 to 6: Production of Molded Articles Using Polyamide Resin Composition

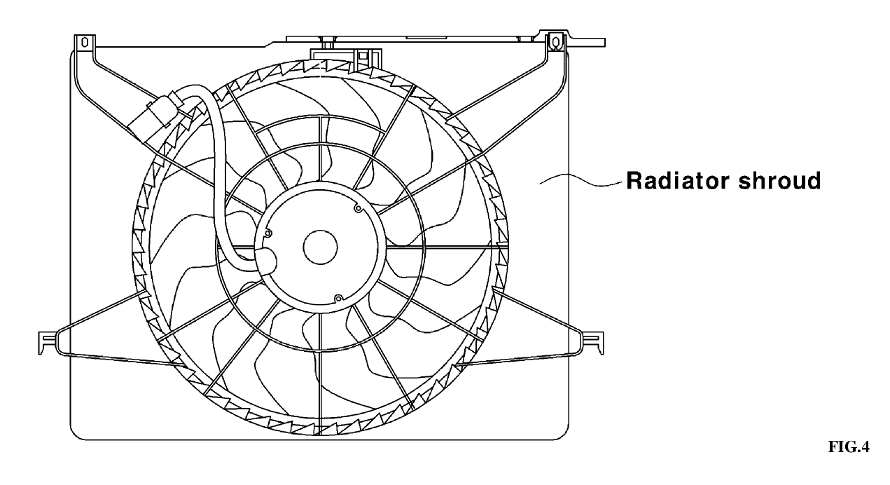

The recycled polyamide 66 resin prepared in Preparation Example 1 and the fiber reinforced polyamide pellet prepared in Preparation Example 2 were air-dried at a temperature of 110° C., the non-recycled polyamide 66 resin was air-dried at a temperature of 70° C., and then they were dry blended according to contents set forth in Table 1, and then was injection-molded to produce a radiator shroud specimen. FIG. 3 illustrated these components and a dry-blended product thereof.

### Comparative Examples 1 to 4: Production of Molded Articles Using Polyamide Resin Composition

Radiator shroud specimens were produced based on contents set forth in the following Table 1 in the same manner as in Example 1.

### Comparative Example 5: Production of Molded Article Using Conventional Polyamide 66 Resin

A polyamide resin composition, which included an amount of 60% by weight of the non-recycled polyamide 66 resin of Preparation Example 3 and 40% by weight of an inorganic substance comprising a glass fiber (chopped glass fiber) having an average diameter of 9 to 13 μm and an average length of 3 to 5 mm and a mineral powder (in this case, in a weight ratio of glass fiber to mineral powder=45:55), was prepared, produced into a pellet by extrusion and was injection-molded to produce a radiator shroud specimen. Here, the mineral powder was an inorganic substance consisting of kaolin and wollastonite.

TABLE 1
Polyamide resin composition contents (unit: % by weight)

| | | | | | Remarks |
|---|---|---|---|---|---|
| | | | | | Inorganic |
| | Polyamide resin composition (unit: % by weight) | | | | substance |
| | Recycled | PA66/ | Non-recycled | Total | content |
| Items | PA66 (a) | LGF35 (b) | PA66 (c) | content | (wt %) |
| Ex. 1 | 30 | 33 | 37 | 100 | 18 |
| Ex. 2 | 40 | 25 | 35 | 100 | 25 |
| Ex. 3 | 50 | 17 | 33 | 100 | 23 |
| Ex. 4 | 60 | 10 | 30 | 100 | 20 |
| Ex. 5 | 40 | 50 | 10 | 100 | 29 |
| Ex. 6 | 40 | 40 | 20 | 100 | 25 |
| Comp. | 20 | 41 | 39 | 100 | 20 |
| Ex. 1 | | | | | |
| Comp. | 70 | 1 | 29 | 100 | 20 |
| Ex. 2 | | | | | |
| Comp. | 40 | 10 | 50 | 100 | 15 |
| Ex. 3 | | | | | |
| Comp. | 40 | 60 | 0 | 100 | 32 |
| Ex. 4 | | | | | |

### Test Example: Measurement of Physical Properties of Specimens

Physical properties of the specimens produced according to Examples 1 to 6 and Comparative Examples 1 to 5 were measured and results are shown in Table 2.

(1) Specific gravity: measured in accordance with ASTM D792.
(2) Tensile strength: measured in accordance with ASTM D638.
(3) Flexural strength: measured in accordance with ASTM D790.
(4) Flexural modulus: measured in accordance with ASTM D790.
(5) Impact strength: measured in accordance with ASTM D256.
(6) Heat deflection temperature: measured in accordance with ASTM D648.

TABLE 2
Results of measurement of physical properties

| | | | | | | Notched | | |
|---|---|---|---|---|---|---|---|---|
| | | | | | | impact | | |
| | | Reduction | | | | strength | | |
| | Specific | of production | Tensile | Flexural | Flexural | (¼″, room | | |
| | gravity | cost | strength | strength | modulus | temperature) | HDT | Moldability |
| Items | — | — | MPa | MPa | MPa | J/m | ° C. | — |
| Standard | 1.28 or | — | 98 or | 147 or | 5,880 or | 29 or | 210 or | ◯ or |
| value | less | | more | more | more | more | more | more |
| (Target value) | | | | | | | | |
| Ex. 1 | 1.28 | ◯ | 125 | 158 | 6,400 | 66 | 245 | ⊚ |
| Ex. 2 | 1.28 | ◯ | 118 | 155 | 6,300 | 63 | 245 | ⊚ |
| Ex. 3 | 1.28 | ⊚ | 115 | 155 | 6,000 | 60 | 245 | ⊚ |
| Ex. 4 | 1.28 | ⊚ | 105 | 150 | 5,900 | 55 | 245 | ⊚ |
| Ex. 5 | 1.28 | ◯ | 138 | 178 | 7,400 | 78 | 250 | ◯ |
| Ex. 6 | 1.28 | ◯ | 130 | 170 | 7,000 | 73 | 247 | ◯ |
| Comp. Ex. 1 | 1.28 | X | 125 | 165 | 6,700 | 70 | 245 | ⊚ |
| Comp. Ex. 2 | 1.28 | ⊚ | 90 | 138 | 5,200 | 46 | 245 | ⊚ |
| Comp. Ex. 3 | 1.24 | ⊚ | 95 | 135 | 5,000 | 48 | 240 | X |
| Comp. Ex. 4 | 1.38 | Δ | 140 | 182 | 7,500 | 80 | 245 | Δ |
| Comp. Ex. 5 | 1.44 | X | 132 | 172 | 7,800 | 70 | 245 | ◯ |

* Reduction of production cost - ⊚: excellent ◯: good Δ: identical X: increase of production cost
* Moldability- ⊚: excellent ◯: good Δ: medium X: bad

As shown from Table 2, Examples 1 to 6 according to the present invention not only satisfied all mechanical properties required for radiator shrouds and but also were effective in moldability, thereby reducing production cost and specific gravity.

However, Comparative Example 1 did not reduce production costs due to low content of the recycled PA66 resin and Comparative Example 2 did not satisfy desired levels of mechanical properties due to excessively high content of the recycled PA66 resin. In addition, Comparative Example 3 contained 15% by weight of the inorganic substance in total and did not satisfy desired levels of mechanical properties. Comparative Example 4 could not contain 32% or greater of an inorganic substance in total and, although contained, neither reduced production costs nor accomplished desired purposes due to increased specific gravity. Comparative Example 5 contained 40% by weight of an inorganic substance and thus satisfied mechanical properties, but had increased specific gravity.

Accordingly, the polyamide resin composition including the fiber reinforced polyamide pellet and a certain amount of the recycled polyamide 66 resin according to various exemplary embodiments of the present invention may have sufficient mechanical properties, reduces specific gravity and is thus suitable for production of vehicle components.

Although the polyamide resin composition according to the present invention contains a less amount of an inorganic substance (e.g. 30% by weight or less), as compared to conventional polyamide 66 resin compositions (containing 40% by weight or more of an inorganic substance), mechanical properties may be sufficient due to use of the fiber reinforced polyamide pellets, molding processability upon re-extrusion and the problem may be improved. In other words, dispersibility of other additives and the inorganic substance may be imparted to dry blending, thereby being a resin composition more suitable for molded articles.

In addition, the polyamide resin composition according to various exemplary embodiments of the present invention may use a pelleted recycled polyamide 66 resin derived from vehicle waste components, for example, radiator shrouds, radiator fans, radiator end tanks and engine covers. As such, domestic and foreign waste vehicle disposal regulations may be satisfied due to reduced production costs and improved vehicle recycling proportions.

In addition, the polyamide resin composition according to the present invention may include a less amount of inorganic substance than the conventional resin for the molded article, thus realizing reduced weight of raw materials.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A polyamide resin composition comprising:
an amount of about 30 to 60% by weight of a recycled polyamide 66 resin;
an amount of about 10 to 50% by weight of a fiber reinforced polyamide; and
an amount of about 5 to 60% by weight of a non-recycled polyamide 66 resin,
all the % by weight based on the total weight of the polyamide resin composition.

2. The polyamide resin composition according to claim 1, wherein the recycled polyamide 66 resin (a) is obtained from radiator shrouds, radiator fans, radiator end tanks and engine covers derived from waste vehicles.

3. The polyamide resin composition according to claim 1, wherein the recycled polyamide 66 resin comprises an amount of about 20 to 40% by weight of a glass fiber and a mineral powder, based on the total weight of the recycled polyamide 66 resin.

4. The polyamide resin composition according to claim 3, wherein the mineral powder comprises kaolin, wollastonite, or a mixture thereof.

5. The polyamide resin composition according to claim 1, wherein the fiber reinforced polyamide is formed in a pellet.

6. The polyamide resin composition according to claim 5, wherein the fiber reinforced polyamide formed in the pellet has an average length of about 5 to 30 mm and an average diameter of about 15 to 20 μm.

7. The polyamide resin composition according to claim 1, wherein the fiber reinforced polyamide is obtained by impregnating a reinforcing fiber with a polyamide 66 resin having a relative viscosity of about 2 to 3, based on a value measured using a solution of 1 g of a polyamide 66 resin in 100 ml of 96% sulfuric acid at a temperature of 20° C.).

8. A method of manufacturing a molded article, comprising:
obtaining a recycled polyamide 66 resin from radiator shrouds, radiator fans, radiator end tanks and engine covers derived from waste vehicles;
preparing a fiber reinforced polyamide by impregnating a reinforcing fiber with a polyamide 66 resin having a relative viscosity of about 2 to 3, based on a value measured using a solution of 1 g of a polyamide 66 resin in 100 ml of 96% sulfuric acid at a temperature of 20° C.′;
preparing a resin composition by mixing the recycled polyamide 66 resin, the fiber reinforced polyamide and a non-recycled polyamide 66 resin; and
forming a molded article by dry-blending and injection molding the resin composition.

9. The method of claim 8, wherein the recycled polyamide 66 resin comprises an amount of about 20 to 40% by weight of a glass fiber and a mineral powder based on the total weight of the recycled polyamide 66 resin, and the mineral powder comprises kaolin, wollastonite, or a mixture thereof.

10. The method of claim 8, wherein the fiber reinforced polyamide is formed in a pellet and impregnated by pultrusion into the pellet.

11. The method of claim 8, wherein the fiber reinforced polyamide formed in the pellet has an average length of about 5 to 30 mm and an average diameter of about 15 to 20 μm.

12. The method of claim 8, wherein the recycled polyamide 66 resin and the fiber reinforced polyamide are air-dried at a temperature of about 110 to 120° C.

13. The method of claim 8, wherein the non-recycled polyamide 66 resin is air-dried at a temperature of about 70 to 80° C.

14. A molded article comprising a polyamide resin composition according to claim 1.

15. The molded article of claim 14 being a radiator shroud.

16. A vehicle comprising the polyamide resin composition of claim 1.

17. A vehicle comprising the molded article of claim 14.
